(19) United States
(12) Patent Application Publication
(10) Pub. No.: US 2026/0178991 A1
(43) Pub. Date: Jun. 25, 2026

(54) DEVICE AND METHOD FOR ALLOCATING A TRANSPORT VEHICLE TO A TRANSPORT TASK

(71) Applicant: GRABTAXI HOLDINGS PTE. LTD., Singapore (SG)

(72) Inventors: Ranran ZOU, Beijing (CN); Yanjiu HUANG, Beijing (CN); Zijian TANG, Singapore (SG); Chang SUN, Singapore (SG); Aloisius STEPHEN, Singapore (SG); Roy Hao Qiang ZHANG, Singapore (SG); Peng ZHAO, Singapore (SG); Sonia Rita FABRE ESCUSA, Singapore (SG); Jilei ZHENG, Singapore (SG)

(21) Appl. No.: 19/128,182

(22) PCT Filed: Nov. 3, 2023
(86) PCT No.: PCT/SG2023/050731

§ 371 Date: May 8, 2025

(30) Foreign Application Priority Data
Nov. 11, 2022 (CN) 202211413968.8

(51) Int. Cl. G06Q 10/02

(52) U.S. Cl. CPC G06Q 10/02

(57) ABSTRACT

Aspects concern a method for allocating a transport vehicle to a transport task comprising storing, for one or more vehicle type sets a mapping between the vehicle type set and a respective virtual vehicle type, receiving a request for a booking of a transport task, receiving an indication whether a requester of the booking of the transport task accepts that the transport task is performed by any vehicle type of a vehicle type set, determining a virtual vehicle type to which the vehicle type set maps, associating the requested booking with the determined virtual vehicle type, transmitting booking information including the virtual vehicle type to a booking service and the booking service allocating a transport vehicle to perform the requested transport task by selecting a transport vehicle from among the vehicle type set to which the virtual vehicle type included in the booking information maps.

### TECHNICAL FIELD

Various aspects of this disclosure relate to devices and methods for allocating a transport vehicle to a transport task.

### BACKGROUND

A request for a booking of a transport vehicle by a user (e.g. a taxi in an e-hailing service) is typically for a certain vehicle (e.g. taxi) type, e.g. “normal” or “premium” taxi. However, to reduce the waiting time, the user may wish to be flexible and accept vehicles from multiple vehicle types.

Approaches are desirable for efficiently handling such a type of booking requests in a transport system which allow allocation of a vehicle from multiple vehicle types to a transport task.

### SUMMARY

Various embodiments concern a method for allocating a transport vehicle to a transport task comprising storing, for one or more vehicle type sets wherein each vehicle type set includes a plurality of vehicle types, a mapping between the vehicle type set and a respective virtual vehicle type of one or more virtual vehicle types, receiving a request for a booking of a transport task, receiving an indication whether a requester of the booking of the transport task accepts, for a vehicle type sets among the one or more vehicle type sets, that the transport task is performed by any vehicle type of the vehicle type set, determining a virtual vehicle type from among the one or more virtual vehicle types to which the vehicle type set maps, associating the requested booking with the determined virtual vehicle type, transmitting booking information including the virtual vehicle type to a booking service and the booking service allocating a transport vehicle to perform the requested transport task by selecting a transport vehicle from among the vehicle type set to which the virtual vehicle type included in the booking information maps.

According to one embodiment, the booking service is configured to determine the vehicle type set to which the virtual vehicle type included in the booking information maps from the mapping.

According to one embodiment, the method comprises including an indication of the mapping in the booking information.

According to one embodiment, the method further comprises blocking the usage of the one or more virtual vehicle types for bookings in response to a command that allocation of any vehicle type of multiple vehicle types to a booking should not be allowed.

According to one embodiment, the request is received by a booking request reception service and the association of the requested booking with the determined virtual vehicle type and the transmitting of the booking information to the booking service is performed by the booking request reception service.

According to one embodiment, the method comprises simultaneously searching for a vehicle candidate for performing the transport task among all vehicles included in the vehicle type set to which the virtual vehicle type included in the booking information maps.

According to one embodiment, the method comprises selecting a vehicle to perform the transport task among the vehicle candidates found.

According to one embodiment, the method comprises setting a price for the transport task depending on the selected vehicle.

According to one embodiment, the method comprises, in response to a change indication indicating a change of the set of vehicles, for which the requester accepts that the transport task is performed by any vehicle type among them, changing the virtual vehicle type to another virtual vehicle type among the one or more virtual vehicle types to which the vehicle type set maps which consists of the vehicle types for which, after the change, the requester accepts that the transport task is performed by any of them.

According to one embodiment, the method comprises transmitting an update of the booking information to include the other virtual vehicle type to the booking service.

According to one embodiment, the method comprises receiving the request for the booking and receiving the indication from a mobile phone.

According to one embodiment, the method comprises triggering the mobile phone to display the option to accept multiple vehicle types.

According to one embodiment, the method comprises triggering the mobile phone to display the option to accept multiple vehicle types for the booking after having received the request for the booking.

According to one embodiment, the mobile phone displays the option to accept multiple vehicle types and transmits the indication upon a user input accepting the option.

According to one embodiment, the mobile phone displays the option to accept multiple vehicle types during a waiting period for a vehicle of a single vehicle type for which the booking has been initiated on the mobile phone by user input.

According to one embodiment, the method comprises changing the booking from a single vehicle type the virtual vehicle type in reaction to the receiving of the indication.

According to one embodiment, the method comprises storing the mappings per region of a plurality of regions.

According to one embodiment, at least some mappings differ from region to region for at least some of the regions.

According to one embodiment, a server computer system is provided comprising a radio interface, a communication interface and one or more processing units configured to perform the method of any one of the embodiments described above.

According to one embodiment, a computer program element is provided comprising program instructions, which, when executed by one or more processors, cause the one or more processors to perform the method of any one of the embodiments described above.

According to one embodiment, a computer-readable medium is provided comprising program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement including a smartphone and a server.

FIG. 2 shows an architecture for letting a user book a transport by a driver.

FIG. 3 shows a flow diagram illustrating booking creation.

FIG. 4 shows the architecture of FIG. 2 with a flow for adding or removing a taxi type from an MTT (multi taxi type) while the booking service is allocating a vehicle.

FIG. 5 shows a flow diagram illustrating a method for allocating a transport vehicle to a transport task.

FIG. 6 shows a server computer system according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

An e-hailing app, typically used on a smartphone, allows its user to hail a taxi (or also a private driver) through his or her smartphone for a trip.

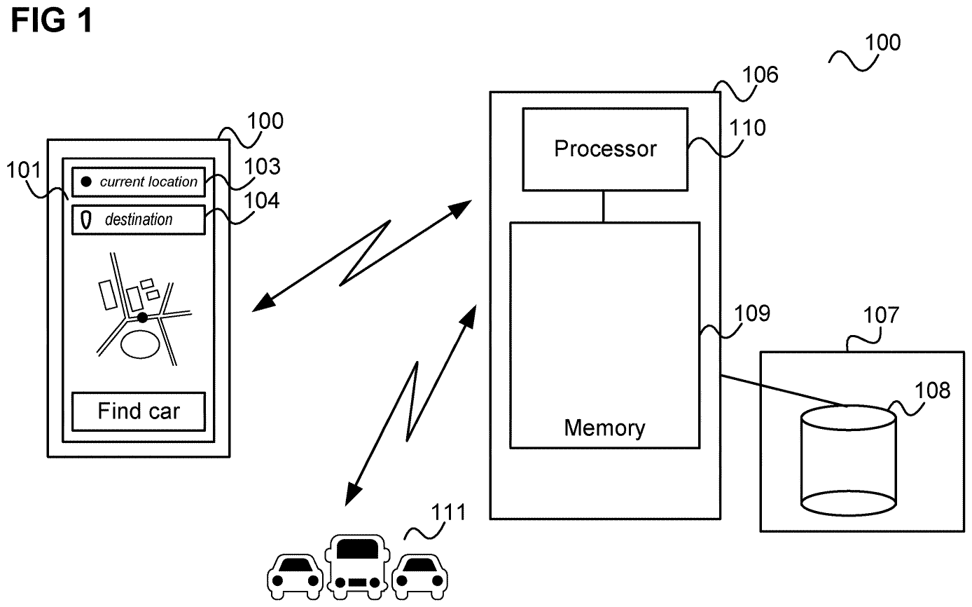

FIG. 1 shows a communication arrangement including a smartphone 100 and a server (computer) 106.

The smartphone 100 has a screen showing the graphical user interface (GUI) of an e-hailing (or similarly delivery, shopping, payment, advertising etc.) application that the smartphone's user has previously installed on his smartphone and has opened (i.e. started) to e-hail a ride (taxi or private driver) or to use any of other above mentioned services.

The GUI 101 includes a map 102 of the vicinity of the user's position (which the app may determine based on a location service, e.g. a GPS-based location service). Further, the GUI 101 includes a box for point of departure 103 (which may be set to the user's present location obtained from location service) and a box for destination 104 which the user may touch to enter a destination (e.g. opening a list of possible destinations). There may also be a menu (not shown) allowing the user to select various options, e.g. how to pay (cash, credit card, credit balance of the e-hailing service). When the user has selected a destination and made any necessary option selections, he or she may touch a “find car” button 105 to initiate searching of a suitable car.

For this, the e-hailing app communicates with the server 106 of the e-hailing service via a radio connection. The server 106 may consult a memory 109 or a data storage 108 having information about the current location of registered vehicles 111, about when they are expected to be free, about traffic jams etc. From this, a processor 110 of the server 106 selects the most suitable vehicle (if available, i.e. if the request can be fulfilled) and provides an estimate of the time when the driver will be there to pick up the user, a price of the ride and how long it will take to get to the destination. The server communicates this back to the smartphone 100 and the smartphone 100 displays this information on the GUI 101. The user may then accept (i.e. book) by touching a corresponding button. If the user accepts, the server 106 informs the selected vehicle 111 (or, equivalently, its driver), i.e. the vehicle the server 106 has allocated for fulfilling the transport request.

It should be noted that while the server 106 is described as a single server, its functionality, e.g. for providing an e-hailing service (or other service as mentioned above) for a whole city, will in practical application typically be provided by an arrangement of multiple server computers (e.g. implementing a cloud service). Accordingly, the functionality described in the following provided by the server 106 may be understood to be provided by an arrangement (or system) of servers or server computers (i.e., in other words, by a server computer system).

The data storage 108 may for example be part of a cloud-based system 107 provided by a cloud storage provider to store and access data which it may use for taking decisions, such as information about the location of passengers, drivers and vehicles, their history (earlier orders and routes taken) etc.

The e-hailing service may offer taxis of multiple taxi types, e.g. standard taxis and premium taxis. The user may have a first choice (e.g. standard taxi) but may, if a standard taxi is not available, also find an alternative (such as a premium taxi) acceptable. To avoid that a user, when a taxi according to the user's first choice is not available, has to re-do the booking again (selecting the alternative taxi type) so that the user can get a vehicle, the e-hailing service may offer a Multi Taxi Type (MTT) as a taxi type (TT) which includes multiple types (e.g. includes standard taxis and premium taxis), i.e. combines different taxi types into one parent taxi type (or generally vehicle type). This allows a user to book a taxi from among multiple taxi types at the same time (i.e. with the same booking request). By allowing a user to select multiple taxi types at a time the server 106 can distribute demand across different taxi types.

Moreover, the Multiple Taxi Type (MTT) provides users more vehicle choices to reduce waiting time in individual bookings since it allows a user to select multiple taxi types in one booking and if a vehicle of any of the multiple types is allocated the booking succeeds. So, Multiple Taxi Type allows increasing allocation rate.

To make a user adopt the selecting of the Multiple Taxi Type in one booking the server 106 may (via the GUI 101), when the user creates a transport booking request via the app, when user is waiting for results of available taxis in an allocation page of the GUI, pop up a window (e.g. including a list of possible additional taxi types) to propose to the user to add some taxi types to decrease waiting time. This advises the user to add vehicle types while the user is waiting for results of a booking. When the user adds one or more additional vehicle types the server 106 changes the booking to an MTT booking. In the underlying implementation, the server 106 may update the booking type of the booking from regular booking type to MTT booking type.

The basic multiple taxi processing may follow one of two approaches: one is using a sequential strategy to schedule bookings for the taxi types belonging to the MTT according to a sequence of taxi types. Another approach is using a simultaneous strategy: the server 106 would try to get the candidates of all selected taxi types (i.e. all taxi types belonging to the MTT) at the same time instead of getting candidates from one taxi type to another sequentially.

According to various embodiments, the simultaneous strategy is used. This is done by creating a Virtual Taxi Type ID which represents a MTT-typed transport booking. Using the virtual taxi type allows abstracting the underlying booking details. By this kind of abstraction, the server 106 can support any combination of arbitrary taxi types to satisfy the requirements from some specific user groups and scenarios with very low cost. For example, a MTT may contain a car sharing type and queuing (which is a background long time lasted activity) to satisfy several user requirements in one booking page. In a sequential approach vehicle types late in the sequence will not be able to get scheduled when using queuing and if there are vehicles available late in the sequence of the vehicle types, but queuing is performed for a vehicle type earlier in the sequence the available vehicles waiting are blocked and time for the user is increased.

In contrast, the simultaneous approach according to various embodiments makes it possible to concurrently schedule bookings for all the selected vehicles types without blocking.

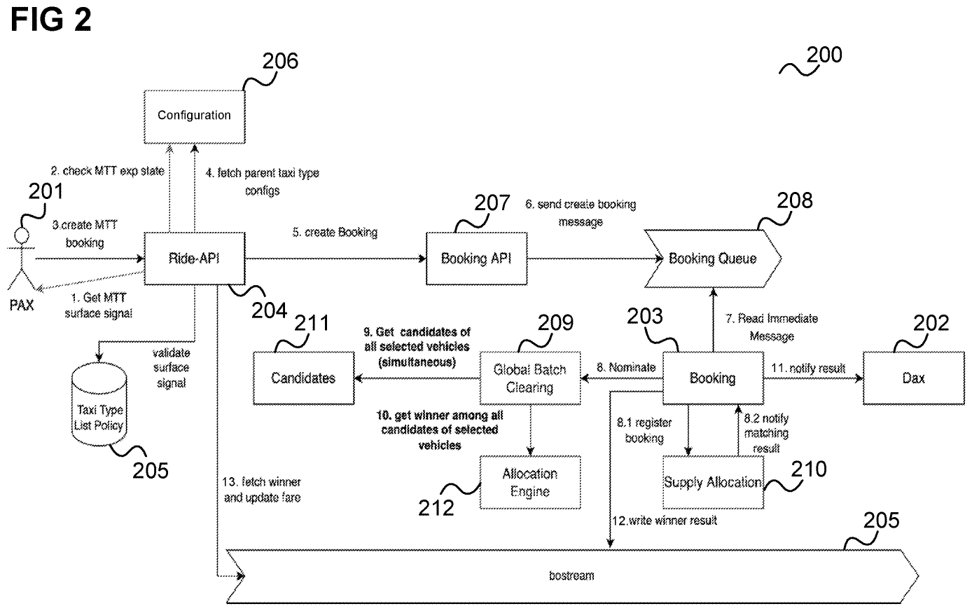

FIG. 2 shows an architecture 200 for letting a user 201 book a transport by a driver 202. This architecture is for implemented by the server 106 to provide the e-hailing service.

It should be noted that while the present example is described for e-hailing, embodiments may also be applied to other services where a user gives an order from his or her mobile terminal for a service involving a transport, i.e. an order for any kind of transport service or transport-related service such as food or parcel delivery. Accordingly, while making reference to taxis in the present examples, these may also in general be transport vehicles including cars, vans, motor bikes, bikes etc. E-hailing is only used as an example in the following. Accordingly, taxi type may in general be a vehicle type and a virtual taxi type or a multiple taxi type may be a virtual vehicle type or a multiple vehicle type, respectively.

The architecture 200 comprises a booking service 203 which plays a key role in scheduling bookings to support different vertical teams, such as transport, food and delivery.

As mentioned above the MTT is a virtual type of taxi used by a ride API, the booking service 203 and other downstream services. It may be possible to turn off MTT in the architecture (and thus the booking flow) in case of errors. This can be done by turning off the virtual taxi type (i.e. blocking usage of the virtual taxi type).

The booking flow is for example as follows
1) The user's smartphone gets a MTT surface signal from the ride API 204 (provided that MTT is an allowed type according to the taxi type policy 205). Accordingly, the GUI 101 displays MTT as an option to the user. The ride API 205 can be seen as providing a booking request reception service (here for the user 201).
2) The ride API 204 checks the MTT exp state (i.e. checks whether the usage of MMTs is turned on or off) with an MTT configuration module 206.
3) The user 201 creates an MTT booking.
4) The ride API 204 fetches the MTT configuration from the MTT configuration module 205, e.g. checks which taxi types belong to the MTT.
5) The ride API 204 creates a booking with a booking API (where it may indicate information from the MTT configuration such as the taxi types which belong to the MTT)
6) The booking API 207 sends a create booking message to a booking queue 208.
7) The booking service 203 reads from the booking queue 208.
8) The booking server 203 triggers a global batch clearing service, registers the booking at a supply allocation module 210 and receives a matching result from the supply allocation module 210. The matching result provides one or more potential matching candidate drivers.
9) The global batch clearing module 209 gets (final) candidates (i.e. candidate drivers) from a candidate service 211 (simultaneously) of all taxis types of the MTT.
10) The global batch clearing module 209 gets the winner of the candidates (e.g. according to user selection) from an allocation engine 212
11) The booking service 203 informs the respective (winner) driver 202.
12) The booking service 203 sends information about the driver 202 to a data stream 213.
13) The ride API 204 fetches information about the driver 202 from the data stream 213 and updates the fare.

Decoupling the candidate selection from the ride API 204 and the booking service 203 from allocation engine allows making individual changes at these different modules for changing the behaviour.

Allocation (i.e. selection among the candidates) may consider multiple factors, such as price, ETA (estimated time of arrival) and waiting time etc. The global batch clearing 209 hands over the task of the selection (i.e. decision) to the allocation engine 212. The allocation engine 212 receives all the necessary information and chooses the winner candidate according to the configured preferences (e.g. defined for the city and/or country where the user is). The configuration of the allocation engine 212 may be changed to change the allocation strategy.

The global batch clearing 209 gets the candidates of all selected vehicle types simultaneously from the candidate service 211. The global batch clearing 209 gets the winner result among candidates of multiple vehicle types by a request to the allocation engine 209.

The allocation engine 212 receives all candidates of different taxi types in one allocation request from the global batch clearing 209. So, the allocation engine 212 would have a larger scope and more data to decide which candidate is best (e.g. depending on city and/or country where the user is). This may increase the efficiency of the supply system. Using a MTT allows performing allocation shaping when there is low supply of some taxi types since an MTT booking can still get sufficient candidates from other taxi types to allow fulfilment.

The usage of MTT as in accordance with the architecture 200 reduces the user's operating costs and waiting time and enables users to have more time to pay attention to other things instead of paying attention to the driver result, and improve successful rate in some edge cases (for example, there are less drivers or there are too many users).

A mapping between virtual (MTT) vehicle type and real vehicle types selected for the virtual vehicle type is defined and stored, e.g. in the configuration module 206. This kind of information is passed through the whole booking flow just in the way of creating a new field and being added into booking details (i.e. to the booking detail data structure) which is the main data structure to represent booking in booking service. Only related modules would be aware of this mapping.

The supply-allocation service 210 registers/deregisters the vehicle types in a region (e.g. corresponding to a geo hash) when it is receiving a register/deregister request from the booking service 203 in an allocation supply cooldown scenario. Allocation supply cooldown scenario aims to provide another way to find candidate drivers. For this, when a booking is created the booking and its target vehicle type in is registered in its region. The region is represented by a GeoHash. So, all pending bookings may be queried in one region by using GeoHash. When the supply of drivers is very low, the normal global batch clearing may fail to find candidate driver periodically. Allocation supply consumes driver location change events. Allocation supply uses a location change event to check whether there are any proper bookings in a region. Since MTT has multiple sub-vehicle types in one booking, multiple pairs of booking code and its sub-vehicle types are registered in the region for a booking with MTT. When a booking with MTT is cancelled or completed in a region, it is remove (deregistered) in the region. So, for each geo hash, there are records of mapping between booking code and taxi type (which may include MTT). In order to match the driver's taxi type with a booking having MTT as taxi type, the virtual vehicle type of the booking with multiple taxi types is replaced by real vehicle types selected for the MTT. Vice versa all the taxi types selected for the MTT of this booking are deregistered when the booking is removed from the region (e.g. geo hash).

The booking process may include post allocation processing when a booking gets a winner driver. The post allocation process includes updating the winner fare to FLS (Fare Lifecycle Service, i.e. a fare service which stores fare information for bookings) and updates the booking state in storage. This post allocation process is triggered when the ride API 204 receives the winner message from the data stream 213. Offline message processing ensures the consistency of winner message consuming. A monitoring of the state of the booking queue 208 may also be provided.

TABLE 1
Table 1 gives an example of a booking detail data structure.

// MTTAllocation contains info about multiple-vehicle-type booking in Transport
// Rides-API will store this data in storage, such as redis.
type MTTAllocation struct {
BookingCode string ‘json:″bookingCode,omitempty″‘
OriginalTaxiTypeId int64 ‘json:″bookingCode,omitempty″‘
VirtualTaxiTypeID int64 ‘json:″virtualTaxiTypeID,omitempty″‘ //
VirtualTaxiTypeID is the taxi type id of MTT 2.0
TaxiTypeIDs [ ]int64 ‘json:″taxiTypeIDs,omitempty″‘ //
TaxiTypeIDs contains all the taxi types in MTT booking
ServiceNames map[int64] ‘json:″serviceNames, omitempty″‘
MTTVersion int64 ‘json:″mvtVersion,omitempty″‘
FareList map[int64]*MTTFareItem ‘json:″mttFls,omitempty″‘
}
type MTTFareItem struct {

| | |
|---|---|
| VehicleTypeID | int64 |
| OriginalLowerBound | float64 |
| OriginalUpperBound | float64 |
| FinalLowerBound | float64 |
| FinalUpperBound | float64 |
| PaidArrearsInfoLowerBound | float64 |
| PaidArrearsInfoUpperBound | float64 |

| | |
|---|---|
| SeriesID | string |
| FareID | string |

| | |
|---|---|
| PaymentTypeID | string |

| | |
|---|---|
| UUID | string |
| ID | int64 |
| Type | string |
| Name | string |

| | |
|---|---|
| AmountOff | float64 |
| PercentageOff | float64 |
| PercentageOffCapAmount | float64 |
| PostDiscountMin | float64 |
| ExcludeTolls | bool |

| | |
|---|---|
| Mode | int64 |

| | |
|---|---|
| CoefficientTimes100 | int64 |
| CurrencyCode | string |

}

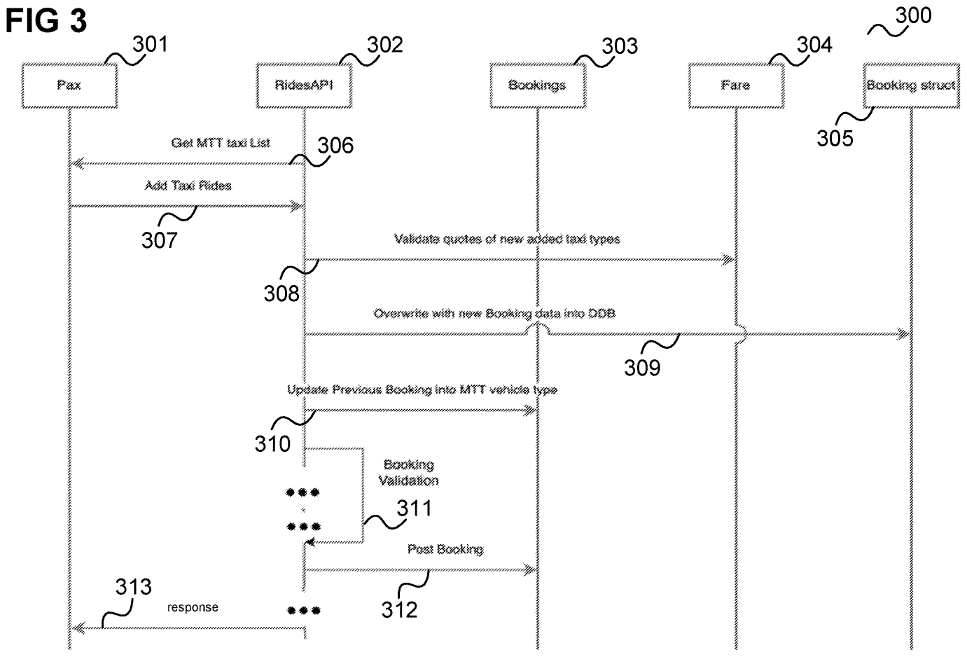

FIG. 3 shows a flow diagram 300 illustrating booking creation.

A user 301 (i.e. the user's smartphone), e.g. corresponding to the user 201, a ride API 302 corresponding to ride API 204, a booking service 303 corresponding to booking service 203, fare data 304 and a booking data structure 305 (e.g. both included in the data stream 213).

In 306, the ride API 302 provides a list of taxi types that the user 301 may include in a previous booking (to become a MTT booking).

In 307, the user adds taxi types that the user wants to include as possibilities in the booking.

In 308, the ride API validates quotes of the added taxi types by accessing the fare data 304.

In 309, the ride API overwrites the previous booking data to include the information that it is now an MTT booking.

In 310, similarly, the ride API 302 updates the previous booking to be of MTT type in the booking service 303.

In 311, the ride API 302 performs booking validation.

In 312, the ride API 302 posts the validated booking to the booking service. It should be noted that the type change of the booking from single vehicle type to MTT type involves some major data modification to the booking including packing sub-vehicles data. So, the booking is validated and posted to replace the existing booking data.

In 313, the ride API 302 responds to the user 301.

It should be noted that according to various embodiments, for a normal booking (i.e. a booking with thus not have the MTT type) a fare is associated with the booking's booking code. This fare stays constant (i.e. will not be changed).

Since the fare of MTT booking however depends on the type of the taxi which is allocated with for the booking, the fare is only established when a taxi has been successfully allocated to the booking the fare. Therefore, according to various embodiments, the fare is included as a data element (field) into the booking data structure.

For an MTT type booking, this information element may at first be set to empty (and a fare service may be given an empty fare) or the fare may at first be set according to one of the vehicle types selected for the MTT. When the state of the booking changes to allocated then the fare is accordingly set to the type of the taxi allocated (and given to the fare service).

In case a booking is cancelled and should be reallocated the handling of the fare function follows the logic of creating a booking.

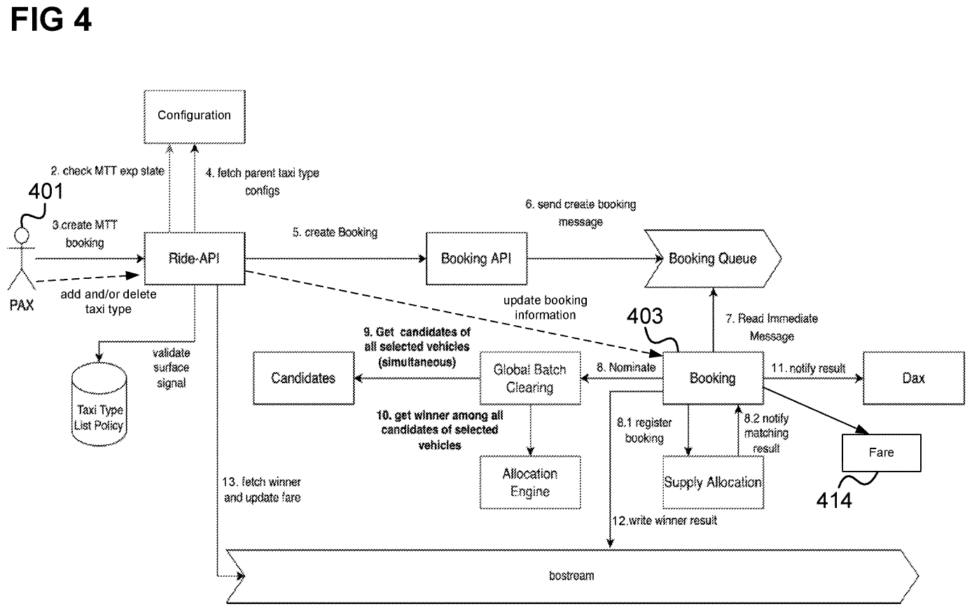

FIG. 4 shows the architecture of FIG. 2 with a flow for adding or removing a taxi type from an MTT while the booking service 403 is allocating a vehicle.

The user 401 may add or delete a taxi type from a created booking by sending (from the user's smartphone) a corresponding modification request to the ride API (triggered by the user 401 making a corresponding selection in the e-hailing app).

The ride API then sends an update of the booking information to the booking service.

FIG. 4 further illustrates that, as mentioned above, when a vehicle has been allocated (i.e. a winner vehicle has been determined) the fare is set accordingly in a fare module 414.

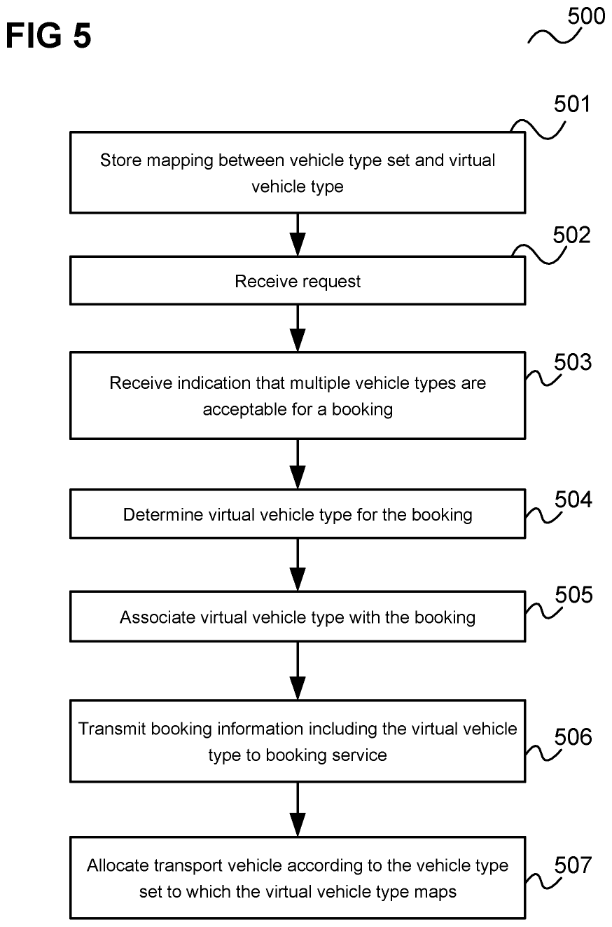

In summary, according to various embodiments, a method is provided as illustrated in FIG. 5.

FIG. 5 shows a flow diagram illustrating a method for allocating a transport vehicle to a transport task.

In 501, for one or more vehicle type sets wherein each vehicle type set includes a plurality of predetermined vehicle types, a mapping between the vehicle type set and a respective virtual vehicle type (referred to MTT in the examples described above) of one or more virtual vehicle types is stored.

In 502, a request for a booking of a transport task is received.

In 503, an indication whether a requester of the booking of the transport task accepts, for a vehicle type sets among the one or more vehicle type sets, that the transport task is performed by any vehicle type of the vehicle type set, is received.

In 504, a virtual vehicle type is determined from among the one or more virtual vehicle types to which the vehicle type set maps.

In 505, the requested booking is associated with the determined virtual vehicle type.

In 506, booking information (e.g. in form of a booking data structure) including the virtual vehicle type is transmitted to a booking service.

In 507, the booking service allocates a transport vehicle to perform the requested transport task by selecting a transport vehicle from among the vehicle type set to which the virtual vehicle type included in the booking information maps.

According to various embodiments, a booking is made for a virtual vehicle type which maps to a set of (real) vehicle types acceptable for a user. This allows processing of the booking largely like a “normal” booking, i.e. a booking for which only one (real) vehicle type is acceptable). The possibility to allocate a vehicle from any of multiple vehicle types is enabled by storage of a corresponding mapping from virtual vehicles types to sets of (real) vehicle types. Each vehicle type may correspond to a respective price (e.g. normal or premium) and/or quality, delivery speed, insurance, vehicle capacity etc.

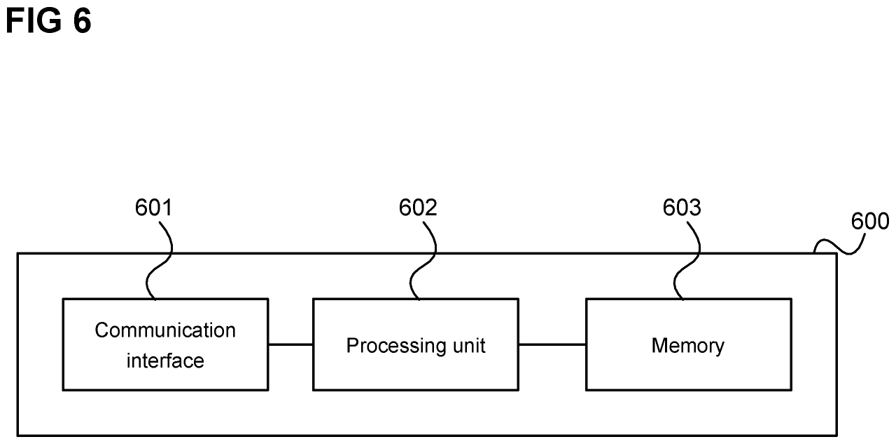

The method of FIG. 5 is for example carried out by a server computer as illustrated in FIG. 6.

FIG. 6 shows a server computer system 600 according to an embodiment.

The server computer system 600 (which includes one or more server computers) includes a communication (e.g. radio) interface 601 (e.g. configured to receive a booking request and the indication from a user's mobile phone). The server computer system 600 further includes one or more processing units 602 and a memory 603. The memory 603 may be used by the processing unit 602 to store, for example, data to be processed, such as information about the mapping. The server computer is configured to perform the method of FIG. 5.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for allocating a transport vehicle to a transport task, comprising:
storing, for one or more vehicle type sets wherein each vehicle type set includes a plurality of vehicle types, a mapping between the vehicle type set and a respective virtual vehicle type of one or more virtual vehicle types;
receiving a request for a booking of a transport task;
receiving an indication whether a requester of the booking of the transport task accepts, for a vehicle type sets among the one or more vehicle type sets, that the transport task is performed by any vehicle type of the vehicle type set;
determining a virtual vehicle type from among the one or more virtual vehicle types to which the vehicle type set maps;
associating the requested booking with the determined virtual vehicle type; and
transmitting booking information including the virtual vehicle type to a booking service,
wherein the booking service allocates a transport vehicle to perform the transport task by selecting a transport vehicle from among the vehicle type set to which the virtual vehicle type, included in the booking information, maps.

2. The method of claim 1, wherein the booking service is configured to determine the vehicle type set to which the virtual vehicle type, included in the booking information, maps from the mapping.

3. The method of claim 1, comprising including an indication of the mapping in the booking information.

4. The method of claim 1, further comprising blocking the usage of the one or more virtual vehicle types for bookings in response to a command that allocation of any vehicle type of multiple vehicle types to a booking should not be allowed.

5. The method of claim 1, wherein the request is received by a booking request reception service and the association of the requested booking with the determined virtual vehicle type and the transmitting of the booking information to the booking service is performed by the booking request reception service.

6. The method of claim 1, comprising simultaneously searching for a vehicle candidate for performing the transport task among all vehicles included in the vehicle type set to which the virtual vehicle type, included in the booking information, maps.

7. The method of claim 6, comprising selecting a vehicle to perform the transport task among the vehicle candidates found.

8. The method of claim 7, comprising setting a price for the transport task depending on the selected vehicle.

9. The method of claim 1, comprising, in response to a change indication indicating a change of the set of vehicles, for which the requester accepts that the transport task is performed by any vehicle type among them, changing the virtual vehicle type to another virtual vehicle type among the one or more virtual vehicle types to which the vehicle type set maps which consists of the vehicle types for which, after the change, the requester accepts that the transport task is performed by any of them.

10. The method of claim 9, comprising transmitting an update of the booking information to include the other virtual vehicle type to the booking service.

11. The method of claim 1, comprising receiving the request for the booking and receiving the indication from a mobile phone.

12. The method of claim 11, comprising triggering the mobile phone to display an option to accept multiple vehicle types.

13. The method of claim 12, comprising triggering the mobile phone to display the option to accept multiple vehicle types for the booking after having received the request for the booking.

14. The method of claim 13, wherein the mobile phone displays the option to accept multiple vehicle types and transmits the indication upon a user input accepting the option.

15. The method of claim 14, wherein the mobile phone displays the option to accept multiple vehicle types during a waiting period for a vehicle of a single vehicle type for which the booking has been initiated on the mobile phone by user input.

16. The method of claim 1, comprising changing the booking from a single vehicle type the virtual vehicle type in reaction to the receiving of the indication.

17. The method of claim 1, comprising storing the mappings per region of a plurality of regions.

18. The method of claim 17, wherein at least some mappings differ from region to region for at least some of the regions.

19. A server computer system comprising:
a communication interface;
a memory; and
one or more processing units configured to:
store, for one or more vehicle type sets wherein each vehicle type set includes a plurality of vehicle types, a mapping between the vehicle type set and a respective virtual vehicle type of one or more virtual vehicle types;
receive a request for a booking of a transport task;
receive an indication whether a requester of the booking of the transport task accepts, for a vehicle type sets among the one or more vehicle type sets, that the transport task is performed by any vehicle type of the vehicle type set;
determine a virtual vehicle type from among the one or more virtual vehicle types to which the vehicle type set maps;
associate the requested booking with the determined virtual vehicle type; and
transmit booking information including the virtual vehicle type to a booking service,
wherein the booking service allocates a transport vehicle to perform the transport task by selecting a transport vehicle from among the vehicle type set to which the virtual vehicle type, included in the booking information, maps.

20. (canceled)

21. A non-transitory computer-readable medium comprising program instructions, which, when executed by one or more processors, cause the one or more processors to perform a method for allocating a transport vehicle to a transport task comprising:
storing, for one or more vehicle type sets wherein each vehicle type set includes a plurality of vehicle types, a mapping between the vehicle type set and a respective virtual vehicle type of one or more virtual vehicle types;
receiving a request for a booking of a transport task;
receiving an indication whether a requester of the booking of the transport task accepts, for a vehicle type sets among the one or more vehicle type sets, that the transport task is performed by any vehicle type of the vehicle type set;
determining a virtual vehicle type from among the one or more virtual vehicle types to which the vehicle type set maps;
associating the requested booking with the determined virtual vehicle type; and
transmitting booking information including the virtual vehicle type to a booking service,
wherein the booking service allocates a transport vehicle to perform the transport task by selecting a transport vehicle from among the vehicle type set to which the virtual vehicle type, included in the booking information, maps.
